(19) United States
(12) Patent Application Publication
(10) Pub. No.: US 2003/0055738 A1
(43) Pub. Date: Mar. 20, 2003

(54) Method and system for effecting an electronic transaction

(75) Inventor: Claude Alie, Ile Bizard (CA)

Correspondence Address: MERCHANT & GOULD PC, P.O. BOX 2903, MINNEAPOLIS, MN, 55402-0903, US

(73) Assignee: MICROCELL i5 INC., Montreal (CA)

(21) Appl. No.: 10/117,623

(22) Filed: Apr. 4, 2002

Related U.S. Application Data
(60) Provisional application No. 60/280,992, filed on Apr. 4, 2001.

(51) Int. Cl. G06F 17/60

(52) U.S. Cl. 705/26

(57) ABSTRACT

A system and method for effecting electronic transactions includes a server for generating a challenge based on a transaction request. The challenge, as well as other information relating to the transaction is sent to a personal mobile device which includes a hardware secure module. The hardware secure module receives the information related to the transaction, prompts the user to approve the transaction and to enter a PIN, and calculates a response which is sent back to the server. The server verifies the response and approves or refuses the transaction based on the response.

### FIELD OF THE INVENTION

The present invention concerns a system and method for effecting an electronic transaction with strong multi-factor end user authentication, remotely using a wireless or a non-wireless personal mobile device. Transactions which can be effected using the system and method of the present invention, include payment, access to a network, and the like.

### BACKGROUND OF THE INVENTION

Mobile communications are evolving from voice only, basic and advanced call control included, to interactive communications and management of a whole range of value-added client/network based applications. This is somewhat similar to the client-server application approach where the mobile handset can be viewed as a remote device, enabling, in the first place, the reception of pushed information (e.g. notifications, alerts, etc.) and in addition, allowing control of server-based applications by making possible the secure communication of control commands and feedback information (e.g. confirmations, processing error reports, etc.). The mobile handset, the server and the network infrastructure work together to define the required service available to the end user.

The client application's (that is, the software program running on the end user device in the mobile environment) complexity corresponds to a technological compromise between ease of mobility, local processing and storage capabilities. Developments in the technology are changing the balance point. For example, the integration of discreet components and miniaturisation result in reduced size, weight and power consumption, enabling more local functions, features, processing, storage capacity and autonomy.

The servers provide the back-end processing and storage capabilities with almost limitless resources.

The wireless networks provide the connectivity between the client and the server. It is normally characterized in terms of coverage and bandwidth. The bandwidth determines the optimal partitioning of the processing and storage capabilities. Small bandwidth will require more local processing (i.e. “fat” client), whereas large bandwidth will usually allow “thin” clients to perform adequately.

One of the platforms for offering mobile telephony is the GSM platform and it provides relatively secure wireless communications capabilities for voice, interactive and connectionless data. GSM networks offer secure communications by using a smart card called a SIM (Subscriber Identity Module) card to provide a secure container for confidential information (e.g. secrets and cryptographic keying material) and a secure processor for cryptography and client application processing. A SIM card must be installed inside all mobile handsets to support the basic GSM secure communication services and this provides the opportunity to run mobile-based applications using SIMAT. SIMAT (SIM Application Toolkit, also known as STK) is a protocol or set of commands that enables applications running within the SIM card to use and control the mobile handset resources (e.g. display, keypad and wireless communications). Through the use of these commands, the SIM-based applications can locally exchange, with the user, the information (e.g. values, PIN, etc . . . ) required for local processing, cryptographic or other, and remotely exchange with a network-based server the result of this processing.

A mobile device so equipped has all the required attributes for effecting a transaction with strong multi-factor end user authentication and can be applied to a whole range of transaction based services.

Transactions are commonplace in today's world, be they payment, or identification, or access to a network, or the like. Most of these transactions, in order to be validated, require an authorization (or consent) authenticated by a combination of robust identification factors. These factors are normally expressions of the following fundamental things: something a person knows (a secret, password, pass phrase . . . ), something a person has (a physical token, a key, . . . ), and something a person is (biometric, signature, . . . ). For example, when paying for an item with a credit card, the card's presence as confirmed by reading the information stored on the magnetic strip on its back, and the card holder's signature permit the merchant to identify and authenticate the person making the transaction. In turn, by signing the transaction, the card holder gives his consent to conclude the given transaction.

It is also common practice, in the banking world of direct debit transaction, to use a PIN (Personal Identification Number—a secret shared between the end user and the financial institution) in combination with a physical debit card, as a digital signature.

FIG. 1 illustrates the method by which a person makes a direct debit transaction and will be examined in more details to identify some of its limitations.

First, the required transaction information must be entered using a Point of Sales Terminal (POST) 106.

Second, the magnetic card 105 must be swiped through the built-in magnetic card reader to obtain the necessary account information. Note that the account information can only be obtained by using the card reader to insure that the card was present (i.e. something a person has) for the transaction. There are currently no accepted methods for manually entering that information if, for example, the card has been accidentally demagnetized. Consequently, as a rule, all direct debit transactions conducted at point of sales terminals and, cash withdrawal carried out at an automatic teller machine (ATM), must have verified the card's presence by having read the card's magnetic information.

Third, basic transaction information is sent to the PIN Pad 108 through a wired connection 107 so that the PIN Pad can be used to enter the required PIN (i.e. something a person knows). This device is a physically secured apparatus used to capture and encrypt the PIN using strong cryptography (typically 3DES encryption) and the bank encryption key to guarantee confidentiality. The resulting data is sent back (using the wired connection 107) to the POST 106 which then transmits, using a telecom connection 104, the complete transaction information to the bank 101 for verification and processing.

Finally, the bank's processing system submits the received encrypted PIN to a Hardware Secure Module (HSM) 103 based server 102 (also called a PIN Box server) for verification. This server decrypts and verifies the PIN within the highly secure container of the HSM 103 and provides a positive or negative response according to the validity of the submitted encrypted PIN. The final confirmation is issued by the bank's processing system after verification of funds availability and sent back to the POST 106 and to the PIN Pad 108.

A key attribute of the PIN Box server 102 is that it is strictly programmed, by careful design of its hardware and software components, to do verification of an encrypted PIN. It cannot output any PIN value, or any other related information, except a positive or negative response to a PIN verification request. The core software executed by the server has gone through rigorous testing, is certified and is finally sealed within the HSM (i.e. protected from change by physical, electrical and logical mechanisms). This process provides system level assurance that the PIN must have been entered at the PIN Pad by the authorized person and, therefore, establishes the foundation leading to non-repudiation of a given transaction.

From an authentication point of view, this process produces a signed transaction with two-factor authentication of different types (i.e. something a person has and something a person knows). The disadvantage with this method is that one of the factors, something a person has, is weak. Because magnetic medium based information can easily be copied, the overall strength of the system is almost entirely dependent on the PIN, resulting in one-factor authentication.

Another payment process used in the banking world requires the use of a smart card. This process leverages two-factor authentication but the factors are used independently. The smart card authenticates the user by verifying the captured PIN with its locally stored value. This provides the first authentication factor (something a person knows). Following a positive verification of the PIN, it then computes a digital signature of the transaction request by encrypting the related information with a unique smart card stored key. The key is called a private key if asymmetrical cryptography is used, otherwise it is known as a secret key when used with symmetrical encryption (e.g. DES or 3DES). This provides the second authentication factor (something a person has) since only the smart card has the capability to transmit the information it has encrypted with its own cryptographic key. The resulting encrypted data is the proof that a specific smart card was used in the process and the strength of this authentication factor is directly related to the strength of the cryptographic technology used by the smart card and the verifying entity (authentication server).

One disadvantage with this process, from a security model point of view, is that all information used for authentication is stored in the smart card, PIN and cryptographic key. If the smart card is compromised then the whole system is compromised. Another disadvantage is that the resulting authenticated signature does not include all the elements used for authentication. The verifying entity can only verify that the right cryptographic key was used (hence the right smart card was used, something the person has) and must trust that the smart card has correctly verified the PIN.

As can be seen from the previous discussion, there is room for enhancement. The present invention leverages the technological advancements found in the now ubiquitous wireless mobile devices mostly used for voice communications. It improves on the current methods by providing a more convenient and secure system for effecting transactions.

### SUMMARY OF THE INVENTION

It is an object of the present invention to provide a method and system for effecting a transaction with strong multi-factor end user authentication, using personal mobile devices that integrate a Hardware Secure Module (HSM usually implemented in the form of a smart card) and user interface capabilities such as display and keypad. Included in the method, is a new light-weight challenge and response protocol for generating a two-factor, strongly authenticated signature particularly well adapted to very low bandwidth and/or user-assisted transmission of transactional information.

A special characteristic of the present method is that there is no need to store user account identification information in the personal mobile device HSM. Some cryptographic keys must be securely injected and stored inside the HSM to make it one of the strong authentication factor (i.e. something a person has).

In accordance with these and other objects, the invention provides a personal mobile device used for effecting transactions with strong multi-factor end user authentication comprising:

means for receiving information related to a transaction and for sending a response;

a hardware secure module for processing said information related to a transaction and for calculating said response, said hardware secure module including encryption keys;

an interface for displaying said information, and for prompting said end user for an identification code; and

means for inputting said identification code and for approving said transaction.

In an advantageous aspect of the invention, there is also provided a system for effecting electronic transactions comprising:

a server and a personal mobile device,

said server being adapted to receive transaction information, to calculate a challenge and to transmit to said personal mobile device information relating to said transaction;

said personal mobile device including:

means for receiving information related to a transaction and for sending a response;

a hardware secure module for processing said information related to a transaction and for calculating said response, said hardware secure module including encryption keys;

an interface for displaying said information, and for prompting said end user for an identification code; and

means for inputting said identification code and for approving said transaction.

### BRIEF DESCRIPTION OF THE DRAWINGS

The present invention and its advantages will be more easily understood after reading the following non-restrictive description of preferred embodiments thereof, made with reference to the following drawings in which:

FIG. 1 shows a prior art direct debit transactions system's components;

FIG. 2 is a schematic representation of the overall transactional process of the present invention;

FIG. 3 identifies the main functional components of the authenticated signature system;

FIG. 4 details the authentication server components;

FIG. 5 details the personal mobile device components;

FIGS. 6, 7a, 7b and 8 describe the three step authenticated signature process;

FIG. 9 describes in more details the challenge value calculation;

FIG. 10 illustrate the actions require to produce a response (signature);

FIG. 11 identifies the activities needed to verify the response; and

FIGS. 12, 13 and 14 are schematic representations of the system of the present invention according to preferred embodiments thereof.

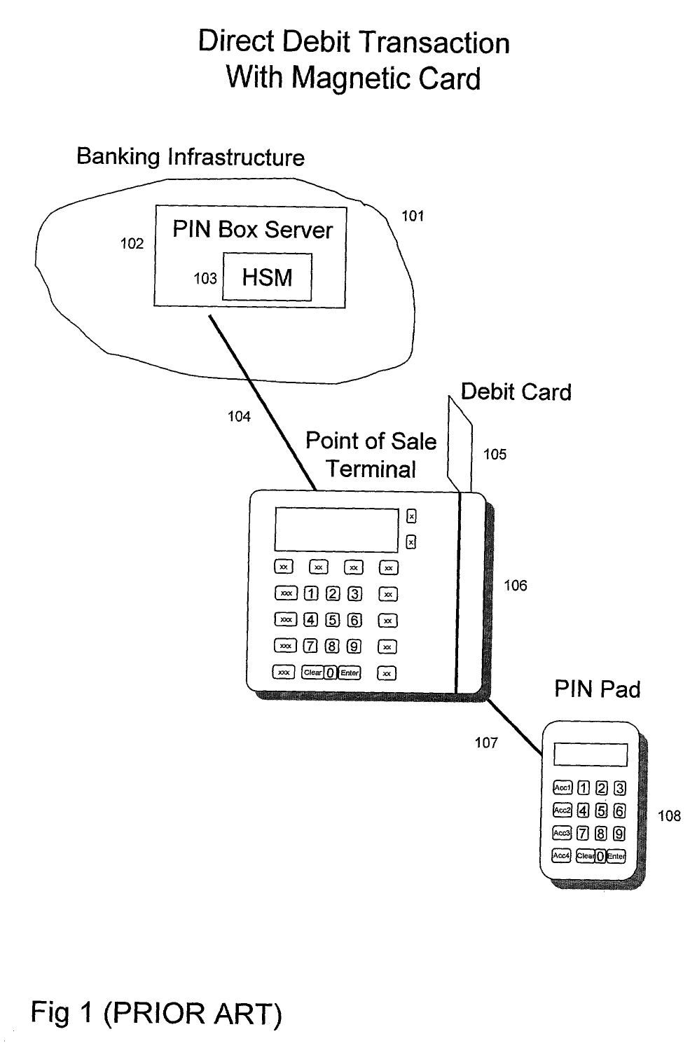

### DESCRIPTION OF A PREFERRED EMBODIMENT OF THE INVENTION

The present invention consists of a system and method for effecting transactions with strong multi-factor end user authentication, using personal mobile devices. The essence of the invention lies in the centralization of the authentication and in the decentralization of the authorization of the person/transaction.

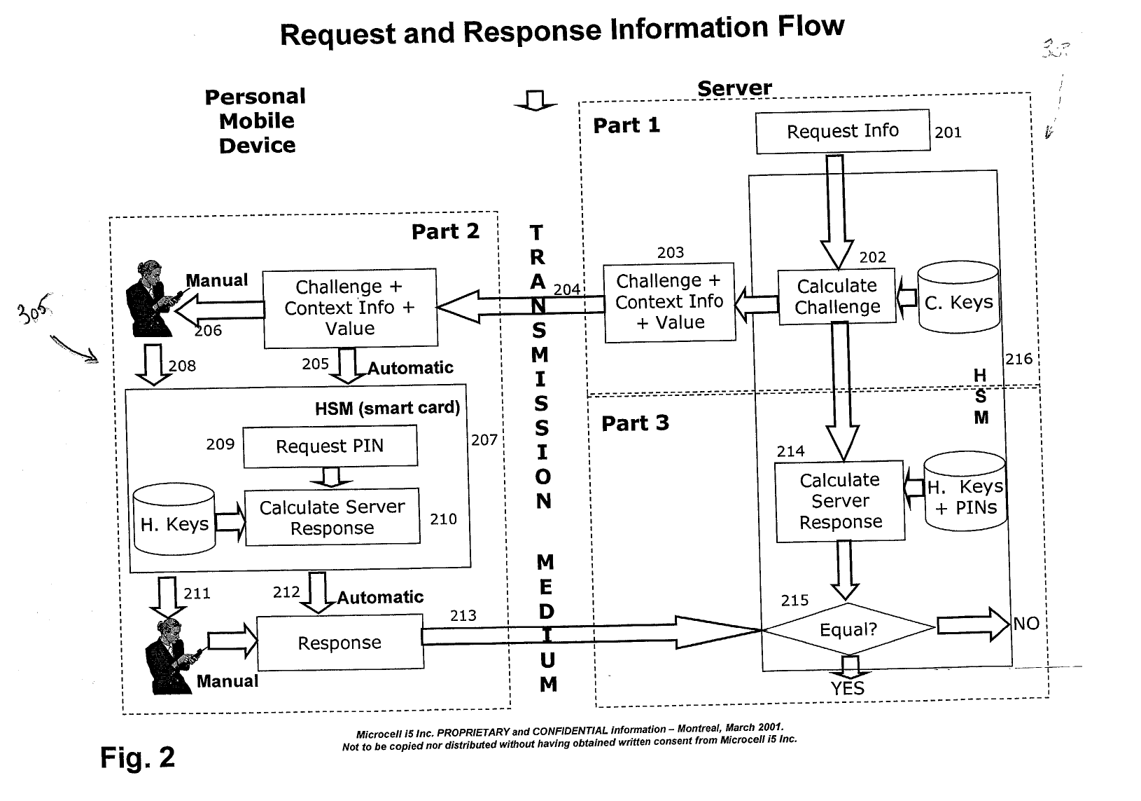

The present invention is based on a client-server architecture and the process is divided into three parts (see FIG. 2).

Part 1 includes the authentication server side processing of the transaction request. The authentication server sends the request information 201 to its own HSM 216 to obtain a derived challenge value 202 (a non-predictable number) which is attached to a label containing context information as well as a numerical value pertaining to the transaction (transaction value, transaction number, or other), so that the transaction is uniquely identified. These three elements 203 are sent 204 to a personal mobile device equipped with a Hardware Secure Module, or HSM, preferably implemented in the form of a removable smart card.

Part 2 consists of the procedure implemented by the personal mobile device (e.g. a personal digital assistant or a mobile handset), including its own HSM 207, to calculate and send back a response 213 (signature). The basic characteristic of the HSM application supporting this process is that it is a small software program that uses the personal mobile device's interface means for interfacing with the server and a person.

At the personal mobile device, the three elements 203 sent by the server are transferred to and processed by the HSM 207. If the personal mobile device has a direct connection, e.g. through a wireless link, to the server then the transfer of all elements is automatic 205. If it has an indirect connection, for example the information is shown on a personal computer display, the user must manually transfer 206 two of the three elements (i.e. the challenge and the transactional value) using the personal mobile device input capability 208. The personal mobile device displays the information relating to the transaction, such as the value, and prompts the person for a PIN 209. The HSM uses the PIN, the transaction value, the challenge, and encryption keys to calculate a response 210. The response is sent to the server, automatically 211 or manually 212 depending on the type of the connection 213 with the server.

Part 3 describes the final steps performed by the authentication server to complete the process. The server also uses its own HSM 216 to perform the same response calculations 214, to compare them 215, and if they match, the person making the transaction is authenticated (by virtue of the smart card and the PIN), and the transaction is now considered authorized by the user

It should be noted that the communication between the personal mobile device and the authentication server may take any route. However, the utilisation of wireless connectivity, when available, allows for automation of the exchanges between the authentication server and the personal mobile device resulting in obvious process speed and convenience.

The system and method of the present invention will now be explained in terms of the functional elements required to process transactions and a detailed description of the sequential interactions between those elements will then be presented.

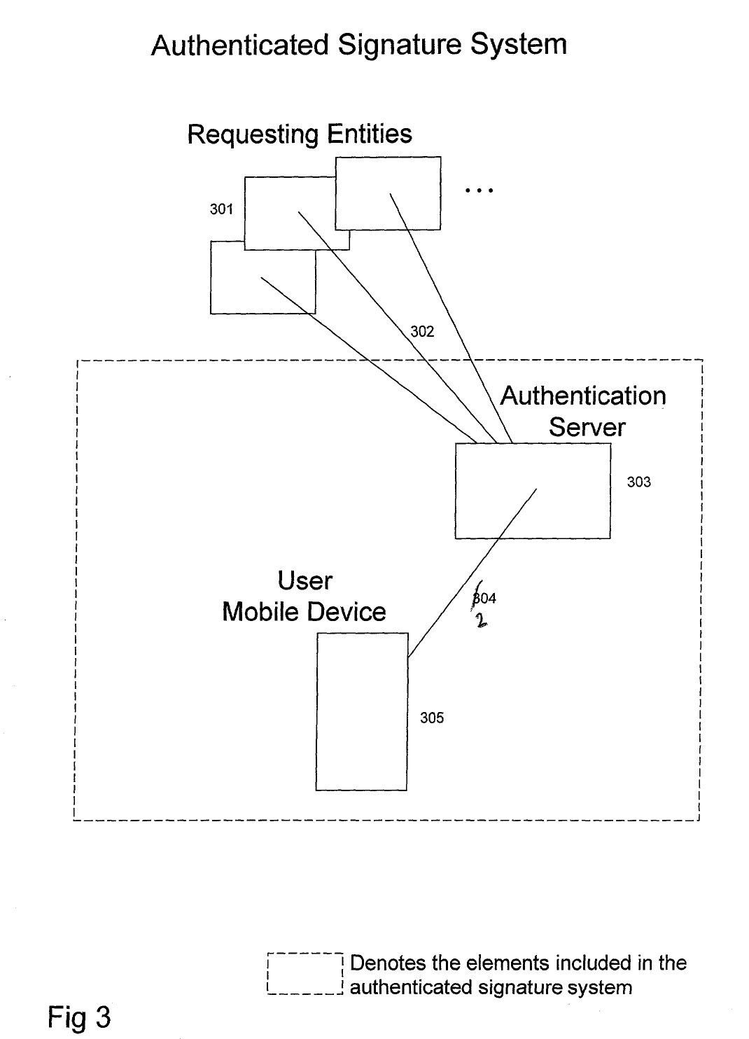

As illustrated in FIG. 3, the authentication signature system is based on a client/server architecture where the two major subsystems are the authentication server 303 and the personal mobile device 305. Requests for authentication from requesting entities 301 are transmitted using conventional telecommunications networks 302 and received by the authentication server 303. These are sent as reformatted signature requests to the personal mobile device 305 through different types of transmission media 304. The personal mobile device 305 receives the signature request, interacts with the user, obtains the required information, and produces a response (a signature) that it sends back to the authentication server 303 through different types of transmission media 304.

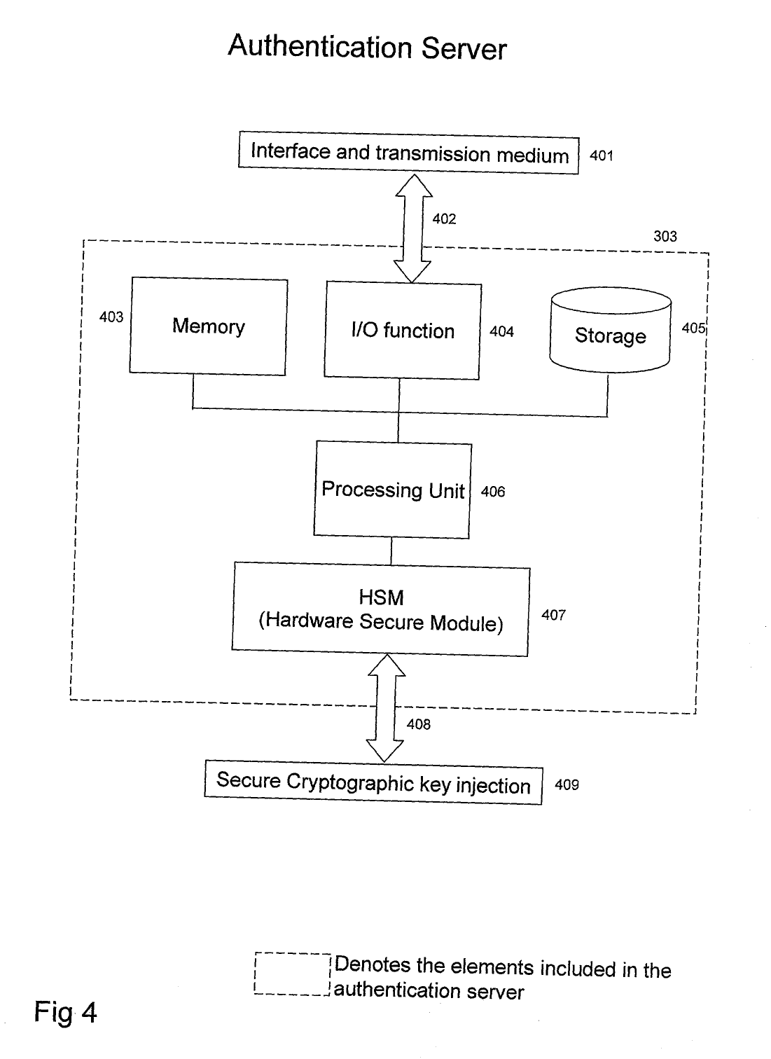

FIG. 4 represents an overview of the functional components included in the authentication server 303. The server interfaces with the different network elements, transmission media and devices 401 through standard data connectivity 402. At the heart of the server 303 is the Hardware Secure Module (HSM) 407. This module is implemented on a cryptographic card that provides physically, electrically and logically protected processing elements to securely process, store and exchange highly sensitive information such as encryption keys. A dedicated port 408 is directly integrated into the HSM 407 to allow secure injection of cryptographic keying material using a specialized input apparatus 409. The processing unit 406, the memory 403, the I/O function 404 and storage 405 elements work together to support the operation of the HSM 407 and to act as a data conduit with the external world 401.

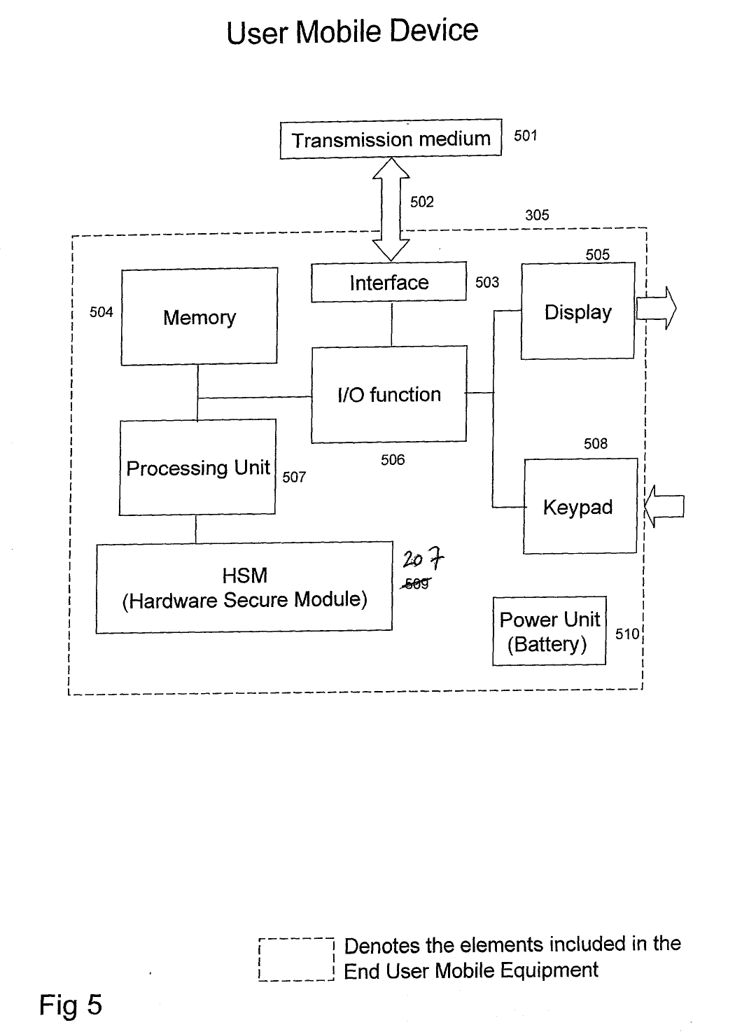

FIG. 5 illustrates the personal mobile device 305 functional architecture and associated components. Also at the heart of the system is a HSM 509, usually implemented as a removable smart card that executes all secure processing and storage functions. Smart cards are complete subsystems that contain their own processing, storage and I/O elements making possible the execution of highly secure applications. The processing unit 507, memory 504 and I/O function 506 provide the glue to support the operation of the HSM 509. The power unit 510 (battery) is the source of electrical energy for both the user mobile device and HSM 509. The interface 503, the display 505 and keypad 508 subunits provide the link with the external world including interaction with the user and data exchange capability 502 with the supporting transmission medium 501.

A detailed explanation of the sequential interactions between those different elements will now be presented.

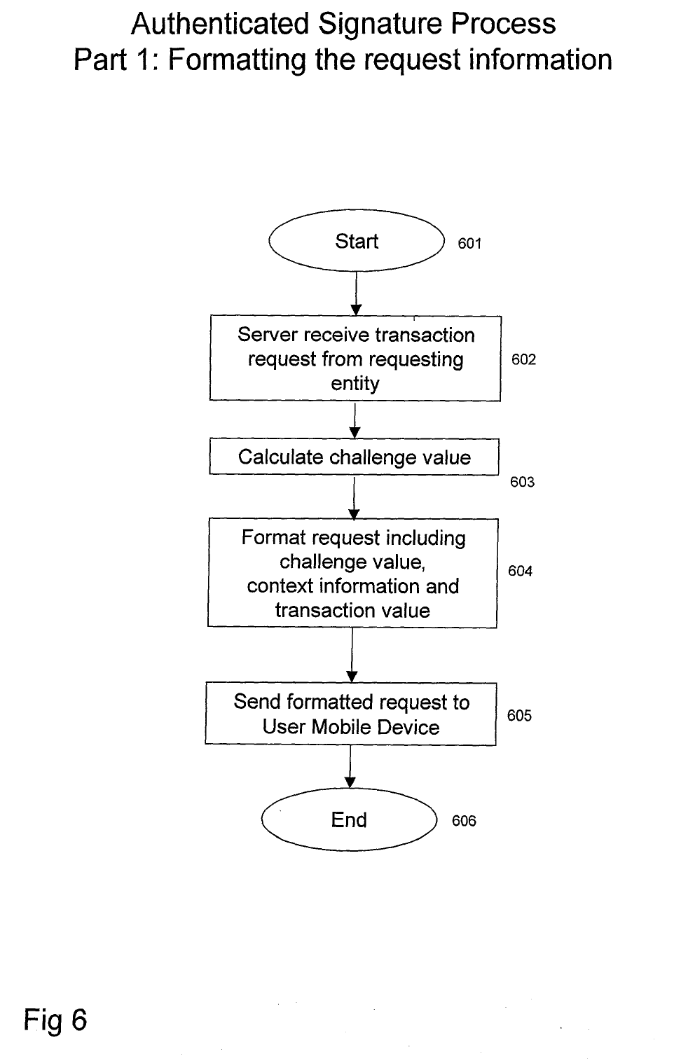

FIG. 6 demonstrates the different steps required to complete the first part of the authenticated signature process. This part is performed by the authentication server and starts with the reception of a transaction request 602 and all information pertaining to it. The server calculates a challenge 603 by applying a cryptographic process to a combination of transaction request and server-issued information. This is to make sure that the resulting value is sufficiently unpredictable to protect against replay attacks. The process for calculating a challenge will be explained in more detail later in the document.

The challenge value, context information and transaction value are joined using a standard format 604 and sent 605 to the user mobile device.

The second part of the authenticated signature process is initiated according to two different events: automatic or manual start of the personal mobile device HSM-based response (i.e. signature) process. This is directly related to the type of communications link available at the time of transaction. If, for example, a wireless mobile device has connectivity with the wireless network and data can be easily exchanged with little delay, the HSM-based application will be activated automatically and will begin interacting immediately with the user. If, however, there are no direct links to the supporting wireless infrastructure, the HSM-based application will require manual activation.

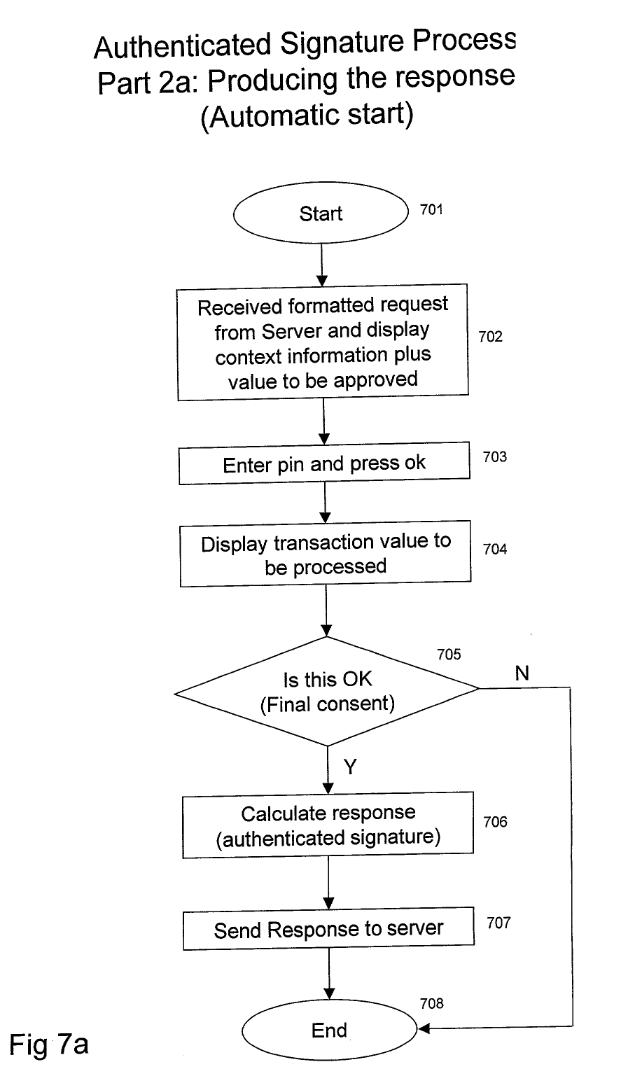

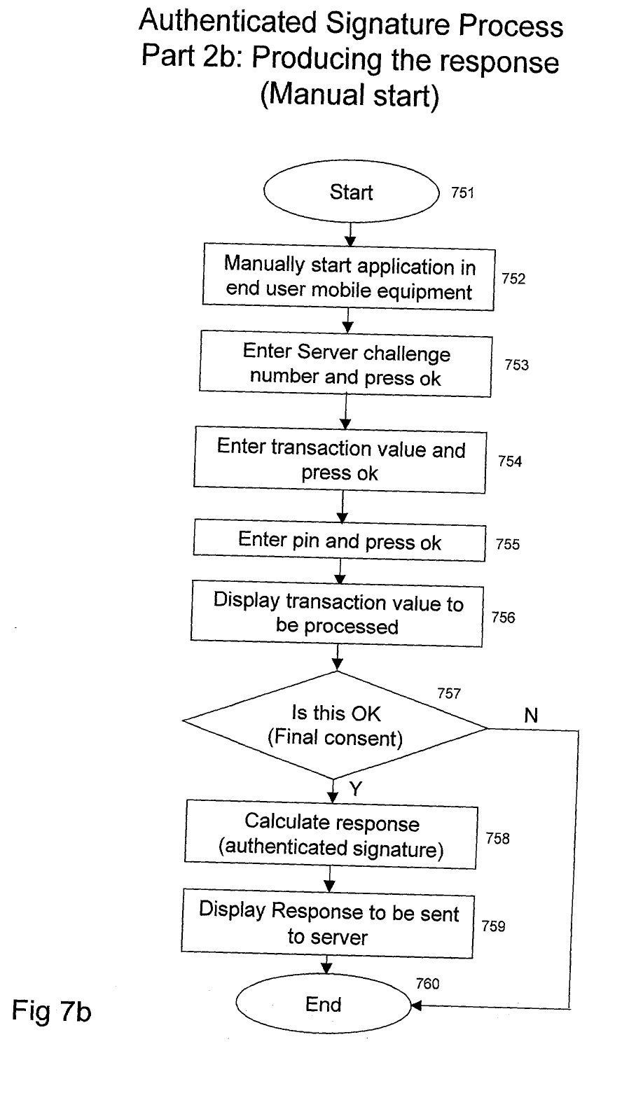

FIG. 7a illustrates the process for producing a response using the personal mobile device with automatic start. It begins when the formatted request information is received 702 by the personal mobile device and is automatically transferred to the HSM, spontaneously activating the execution of the related application. The HSM application extracts the context information and the transaction value from the formatted request information and uses the personal mobile device's output capability to display it. The user is then prompted to enter a PIN 703 using the personal mobile device's input capability. The user is then asked to confirm the transaction value 704 shown on the personal mobile device display by giving his final consent 705. Following a positive confirmation, the HSM application calculates a response 706 (i.e. an authenticated signature) and sends the response back to the authentication server 707 using the personal mobile device's communications capability (e.g. wireless data communications). Note that a negative confirmation can either terminate the process (as shown) or could, for example, result in a jump to a previous step. The process for calculating the response will be explained in more detail later in the document.

FIG. 7b demonstrates the same process as FIG. 7a but with manual start. This happens when the formatted request information could not be directly transmitted to the personal mobile device. For example, if a wireless mobile device is used in a basement with heavy shielding, it is likely that the required radio frequency signal is not available to support the needed data connectivity. Consequently, an alternative channel must be used to deliver the information.

The process starts when the user has access to the formatted request information through the alternate delivery channel (e.g. visually when it is displayed on the computer display) and manually activates the HSM application 752 through a menu item on the personal mobile device. The HSM application uses the personal mobile device's output capability to request the entry of the challenge value 753 as delivered by the alternate channel. The user enters the value using the personal mobile device's input capability and presses the ok key using the same. The user is then prompted to enter the transaction value 754 also delivered by the alternate channel and presses the ok key. The next three steps follow the same sequence as in FIG. 7a. The user is prompted to enter a PIN 755 and to press the ok key. The user is then asked to confirm the transaction value 756 shown on the personal mobile device display by giving his final consent 757. Following a positive confirmation, the HSM application calculates a response 758 (i.e. an authenticated signature) and displays it 759 in such a way that the user can read the value and send it back to the authentication server using an alternative delivery channel (e.g. by typing it on a computer keyboard). Note that a negative confirmation can either terminate the process (as shown) or could, for example, result in a jump to a previous step.

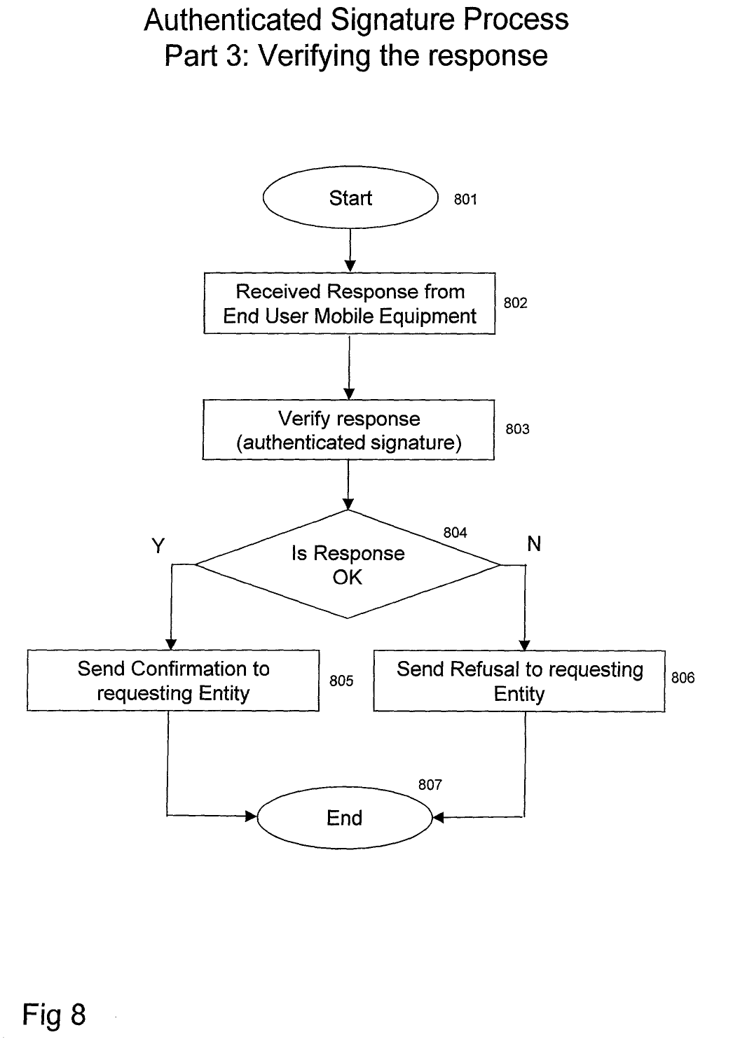

FIG. 8 illustrates the last part (3) of the authenticated signature process and describes the response verification. It begins when the response data sent by the personal mobile device is received by the authentication server 802. The response is submitted to the authentication server HSM 803 which compares it to its own calculations 804. A positive or a negative result initiates the transmission of a confirmation 805 or refusal 806 to the requesting entities. The process for verifying the response will be explained in more detail later in the document.

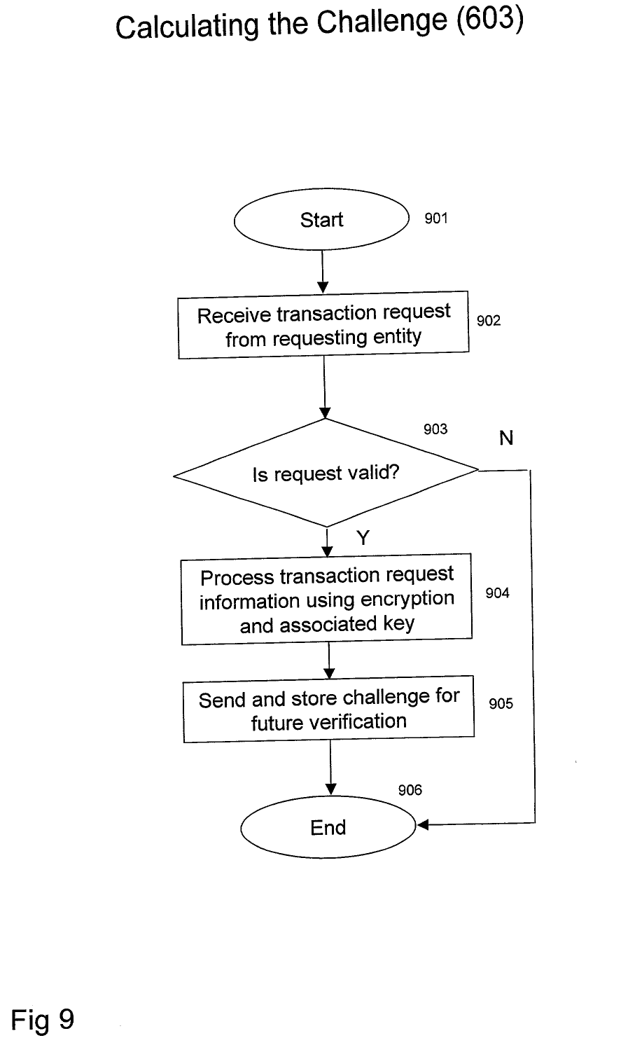

FIG. 9 describes in more detail the process of generating a challenge value. It starts when the authentication server has received a transaction request 902. The server first validates the information included in the request and the authenticity of the requesting entity 903. If the request is not valid the process is terminated. If the request is valid the server submits this information to the HSM 904. The HSM combines the transaction request data with internally generated data (e.g. timestamp, sequential number etc.) and performs a cryptographic transformation of the data using the associated encryption key. The resulting challenge value is sent to the authentication server and stored 905 so that it can be used to verify the response

For example, all data to be processed can be divided in 64 bit blocks and encrypted using 3DES CBC. In cipher block chaining (CBC), individual blocks are chained together and the last encrypted block inherits information from all the previous blocks. This block can be used as a challenge value. Typically, the challenge is derived from a random number generator and has no relationship with any other information. The advantage of the method herein presented resides in the fact that a derived challenge provides a fingerprint of the transaction and allows a very efficient method for exchanging the minimum amount of information required to complete the transaction, yet it remains very secure. This is the first building block needed to create a light-weight protocol for generating two-factor, strongly authenticated signatures.

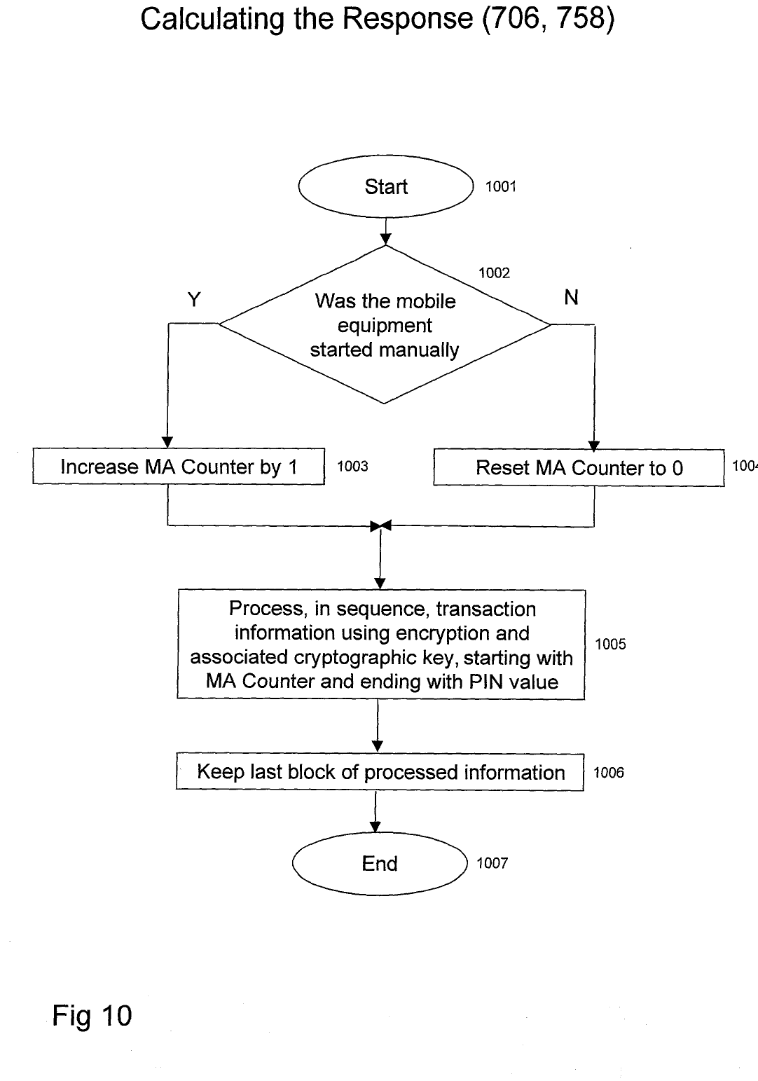

FIG. 10 illustrates more accurately the procedure for calculating the response (signature) which varies according to the condition of activation. It begins by verifying if the personal mobile device HSM application was started manually or automatically 1002. If it was activated manually, a special internal HSM counter (MA) is incremented by one count 1003, otherwise, it is reset to a zero value 1004. This MA (Manual Activation) counter plays a very important role, as it offers strong protection against PIN disclosure attacks and will be discussed in more detail hereinafter. Once the MA counter has been properly set, the HSM application calculates the response 1005, or signature, by encrypting, in sequence, a combination of four information components. The first component is the MA counter and the next one is the challenge value. The third component is optional and can only be used when the HSM application was activated automatically. It includes a variable string of data corresponding to the context information. The last component is the PIN value. The encryption process can be implemented using 3DES in CBC mode and as explained before, the last encrypted block inherits information from all the previous blocks. The cryptographic secret key used to perform the encryption is unique for each individual HSM and the resulting encrypted block of information constitute the final response 1006, or signature. This new process of combining the correct information elements in the right order, corresponds to the second building block needed to create a light weight protocol that binds together, in a condensed form, all input elements and provides strong two-factor authentication by virtue of the PIN and of the cryptographic secret key. The PIN represents the first factor (i.e. something a person knows) and the encryption key the second factor (i.e. something a person has).

As indicated earlier, the MA counter protects against PIN disclosure attacks. Without it, an attacker has the means to mount an attack on the PIN by using the manual activation mode of operation. The first step involves capturing the exchanged information between the authentication server and the personal mobile device during a valid transaction. With the challenge, transaction and response (signature), values the attacker can use the manual activation mode of operation to try out different values of the PIN until a match between the challenge/transaction values and the response value is found. Considering that a typical PIN value is about four digit long, the attack requires, on average, 5000 attempts to find that value. With the MA counter, each attempts increases the counter and generate a different response even when the correct PIN value is used. By making this counter large enough, it is impractical to mount a successful attack on the PIN. This original approach of using a counter for this function, corresponds to the third building block needed to develop a light weight protocol for generating two-factor, strongly authenticated signatures that are practical yet very secure. Other digital signature methods needing to exchange hundreds if not thousands of bytes of information are not suitable for very low bandwidth data services and are essentially impractical for user-assisted transmission of transactional information.

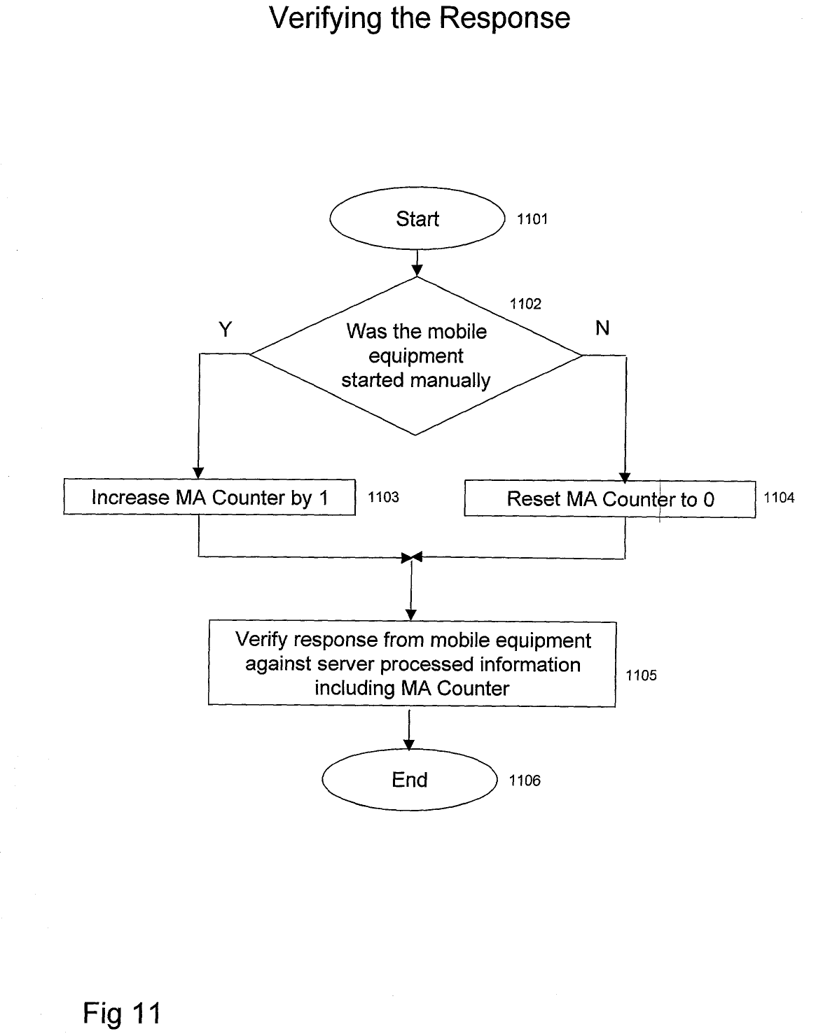

FIG. 11 represents in more detail the procedure of verifying the response as it is received from the personal mobile device. It starts by having the authentication server determine if the response was calculated following a manual or automatic activation of the personal mobile device HSM application 1102. As was indicated earlier, the condition of activation is dependent on the delivery channel used to exchange the information. Consequently, the server establishes the condition of activation (of the personal mobile device HSM application) according to how it has received the response. If the activation was inferred to be manual, a special authentication server HSM based counter (MA) is incremented by one count 1103, otherwise, it is reset to a zero value 1104. This MA (Manual Activation) counter is equivalent to the one implemented in the personal mobile device HSM and the two counters should normally remain synchronized. It is possible, however, that the personal mobile device HSM application was manually activated several times for the same transaction, and that only the last response was successfully transmitted back to the authentication server using the alternate delivery channel. This condition would result in the de-synchronization of the MA counters and, to account for this situation, some tolerance has been built-in the HSM. If the de-synchronization becomes too important, a transaction using the principal delivery channel and the automatic activation of the personal mobile device HSM application must be completed to resynchronize the MA counters. Once the MA counter has been properly set, the authentication server HSM application calculates a local response 1105, according to the same process that was used by the personal mobile device HSM using the same data elements and encryption keys. It then proceeds to compare the two responses and then provides the result in the form of an equal or not equal reply to the verification request. One important aspect of the authentication server HSM function is that it is designed as a black box. This relates to the fact that the HSM can only perform the limited actions it was designed for and that confidential data can never be extracted from it. It is incapable, by design, to output any confidential information that it used to perform the verification of response. The software executed by the HSM has gone through rigorous verification, is audited, certified and finally sealed (i.e. protected from change by physical, electrical and logical mechanisms). With proof that the authentication server HSM application can only verify responses, and cannot output them, the system establishes the necessary conditions leading to non-repudiation (i.e. the response that was verified by the authentication server could only come from the user of the personal mobile device. This is equivalent to the model used by financial institutions to provide the direct debit payment service.

The system and method of the present invention will now be described in reference to preferred embodiments thereof, which should not be interpreted as being limitative, since the above description is applicable to a variety of different embodiments. A special focus will be given to the GSM wireless communications system.

The current implementation of GSM supports digital voice communications, connection-oriented data communications and SMS (Short Message Service—a packet-based communications service). The SMS provides a mechanism that allows the direct exchange of data messages between the SIM (a hardware secure module required by all GSM mobile terminals to support secure communications) and any network-based systems.

An aspect of the preferred embodiment of the present invention makes use of SIM-based applets and server applications. A SIM-based applet is a client application that runs on the SIM and uses the input/output capabilities of the mobile handset to interact with the user. It then uses the communications capability, or input/output capability, of the mobile handset to transmit the information resulting from this interaction to the back-end servers.

The back-end server and the SIM-based applet work together to provide a complete service.

Thus, the present invention makes use of features of GSM mobile handsets to provide a system and method for performing or effecting transactions based on a secure remote control device and a server. Such a mobile handset meets the following characteristics: secure communications and tamper resistant storage and processing (SIM); convivial and simple user interface; and authentication and signing capability (using symmetrical or asymmetrical cryptography).

In order to do so, the present invention contemplates an authentication server-based transmission of a signing request (challenge and information), followed by a SIM-based transmission of a user authenticated signed transaction response.

In broad terms, the process when applied to a GSM system is as follows:

An authentication server requests an end user response by sending to the SIM in the mobile handset, using SMS or other appropriate communications methods including manual entry, a signing request message that contains, as previously described in the document, the following elements: a challenge value, which takes the form of a non-predictable number and is used in a similar way as a secure stamp to protect against replay attacks; and information of the required transaction/control command that can include the type of transaction/control, the value, the source, the destination etc. It should be noted that the first element, the challenge, is derived from the request information using, for example, a cryptographic process.

The SIM-based applet uses the mobile handset to display this information and ask the user to confirm the transaction by entering a secret (i.e. a PIN) only known to the user and the server.

The applet combines the challenge with the required information and the secret to compute a signed response using a cryptographic process in conjunction with encryption keys (e.g. symmetrical encryption or asymmetrical encryption can be used although the later will result in a much larger response message).

The response is sent back to the authentication server for verification using SMS or other appropriate communications means. This response is similar to an authenticated transaction/control command.

The authentication server used the same information and its own HSM to compute a response for comparison and a positive verification of the response will lead to the completion of the transaction/control request. Note that if private key asymmetrical encryption was also used by the SIM in the process of generating the response, the server must first decrypt the SIM response using the related asymmetrical encryption public key before verifying the response.

It should be noted that the communication channel used to exchange the request and response messages between the server and the SIM applets need not be exclusively SMS. In order to support other communications channels, a mechanism is additionally provided to manually enter the request message (i.e. challenge and transaction value) and view the response using the mobile handset keypad and display, by triggering the execution of the SIM-based applet from a menu item of the mobile handset. This mechanism can also be implemented in non-wireless devices in other to provide the same type of functionality and services.

It finally should be noted that signing requests are pushed to the mobile handset. The requests can be initiated by the end user: using a personal computer, a WAP phone, a wire line device using an IVR (Interactive Voice Response) system or by sending an SMS. It can also be initiated by an event: a machine based action such as the balance of a prepaid account reaching a minimum threshold value triggering a request for replenishment or a commercial offer generated by a shopping agent or a promotional advertisement server.

The challenge value, according to a preferred embodiment of the present invention, typically includes the following elements:

a non-predictable number typically having 16 digits for a total of 64 bits (using binary coded decimal (BCD)); this number can be derived using cryptographic methods from the input information based on the request command;

information on the nature of the transaction to provide proper identification of the required response: units, financial institution identification and type of account, in the case of payment services, or the like; and

a transaction value, currently set to a maximum of 8 digits (typically the amount of the transaction).

The applet residing in the SIM requires that a response be calculated using a subset of the information contained in the signing request message, typically the non-predictable challenge value and the transaction value with the addition of the secret information (PIN) entered by the user.

This PIN typically has a minimum of 4 digits and a maximum of 8 digits. The response is calculated from the combination of the challenge value, transaction value and the PIN using, for example, symmetrical cryptography with cipher block chaining making possible a very compact response message, and/or asymmetrical cryptography. Several cryptography techniques will meet the objects of the present invention.

Consequently, the above method can be used in a system for effecting a transaction of any kind, such as access to a network, payment, granting rights etc.

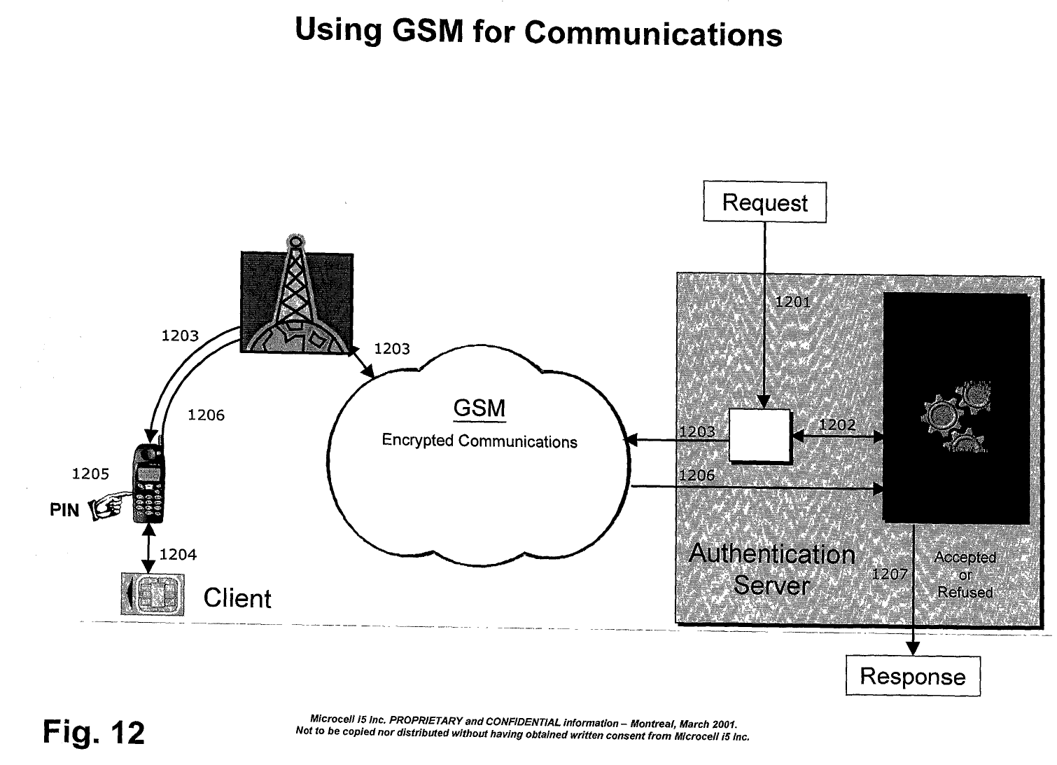

Referring now to FIG. 12, a preferred embodiment of the method and system will now be described. This is a description of the process when GSM based wireless communication is available, using SMS as a means to exchange the information between the authentication server and the wireless mobile device client application (SIM applet in this case). The process is initiated by a service request, as mentioned previously. For example, a service request can take the following form: a user is shopping on-line at a merchant, selects the items to purchase, proceeds to the check-out, and chooses the method of payment in association with the present invention.

The merchant's system then sends a request including the transaction value, merchant ID, and user's unique identifier to the authentication server 1201. The server prepares a signing request 1202 based on the received information, and sends the signing request message 1203 using the SMS transport GSM network elements. The information is packaged for direct delivery to the SIM, transmitted to the mobile handset of the user 1203, and forwarded directly to the SIM 1204. The SIM based application is automatically activated and uses the mobile handset screen to display the appropriate information, such as merchant name, value, items, etc., and prompts the user to enter his or her PIN 1205. When the same has been entered, the SIM applet calculates a response using a cryptographic process and transmits it back 1206 to the authentication server using SMS. The authentication server uses its HSM to calculate a response using the same cryptographic process and compares it to the SIM response. This provides a service response 1207, whether accepted or refused, to the user and to the merchant. If accepted, the fulfilment of the transaction is performed as usual.

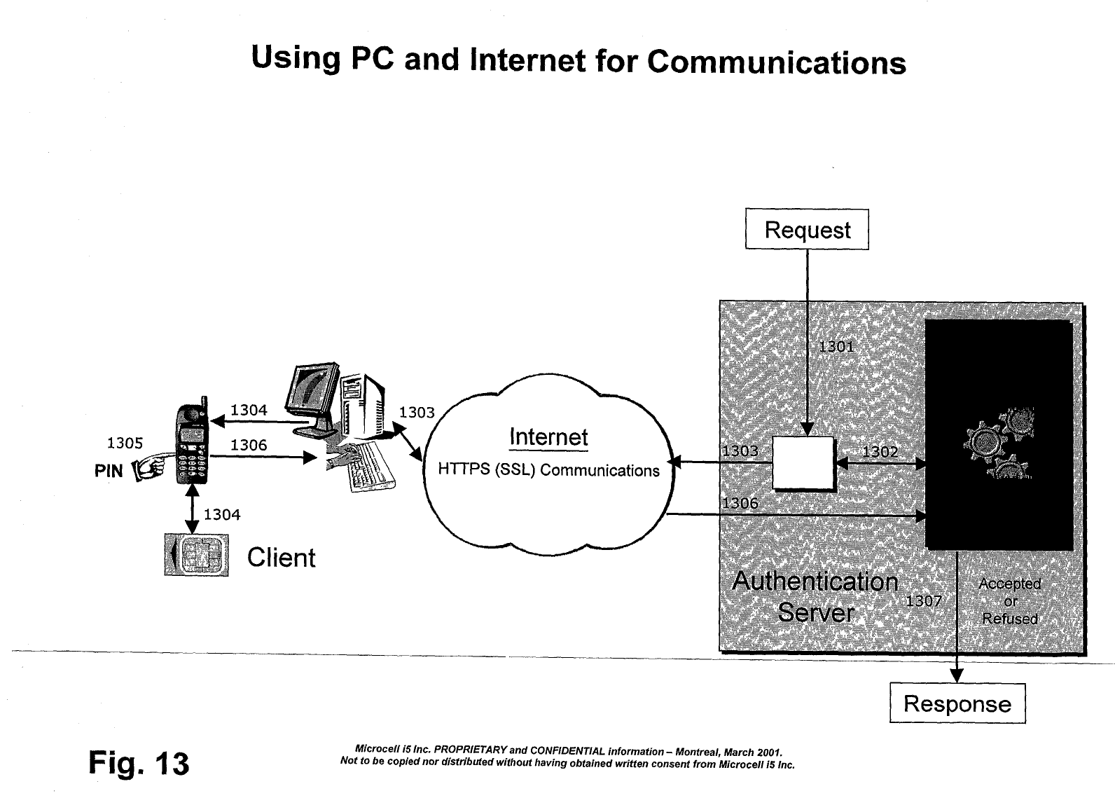

Referring now to FIG. 13, a preferred embodiment of the method and system will now be described where the wireless SMS communications service is not available (e.g. without a wireless radio frequency signal or without service as can be the case when the wireless network's capacity has been exceeded). This is the description of the process using the Internet and a personal computer (PC) as a mean to exchange the information between the authentication server and the wireless mobile device client application (i.e. the SIM applet in the mobile). The process is initiated by a service request, as mentioned previously.

Once the method of the present invention has been selected, the merchant's system sends a request including the transaction value, merchant ID, and user's unique identifier to the authentication server 1301. The server prepares a signing request 1302 based on the received information, and sends the signing request message 1303 through the Internet.

The information appearing on the PC display instructs the user to manually activate the SIM based application from a menu item of the mobile handset, and to enter, in sequence, the proposed challenge and transaction values 1304. The SIM based application prompts the user to enter PIN value 1305. When the PIN has been entered, the SIM applet calculates a response using a cryptographic process and displays it in a readable format on the mobile handset's screen. The user manually enters this response using the PC keyboard for transmission to the authentication server using the Internet 1306. The authentication server uses its HSM to calculate a response based on the same information, and compares it to the SIM response This provides a service response 1307, whether accepted or refused, to the user and to the merchant. If accepted, the fulfilment of the transaction is performed as usual.

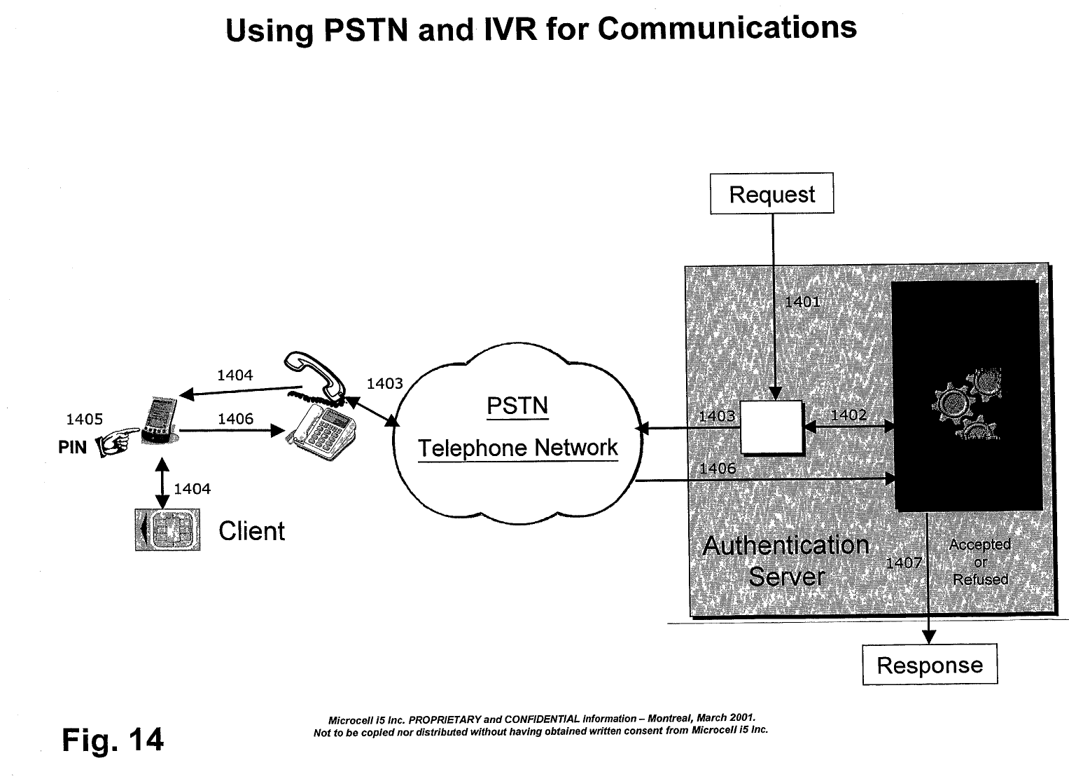

Referring now to FIG. 14, a preferred embodiment of the method and system will now be described where the wireless SMS communications service is also not available (e.g. without a wireless radio frequency signal or without service as can be the case when the wireless network's capacity has been exceeded) but in this case, a smart card equipped device, the public switched telephone network (PSTN), a standard wire line telephone (DTMF) and an Interactive Voice Response platform are used as a means to exchange the information between the authentication server and the smart card equipped device client application (e.g. smart card application in a PDA) The process is initiated by a service request, as mentioned previously.

Once the method of the present invention has been selected, the merchant's system sends a request including the transaction value, merchant ID, and user's unique identifier to the authentication server 1401. The server prepares a signing request 1402 based on the received information, and uses a text to speech process and the Public Switched Telephone Network to verbally provide the necessary information to the user 1403.

This information instructs the user to manually activate the smart card based application from a menu item of the device, and to enter, in sequence, the proposed challenge and transaction values 1404. The smart card based application prompts the user to enter the PIN value 1405. When the PIN has been entered, the smart card based application calculates a response using a cryptographic process and displays it in a readable format on the smart card equipped device's screen. The user manually enters this response using the telephone keypad for transmission to the authentication server through the Public Switched Telephone Network 1406. The authentication server uses its HSM to calculate a response based on the same information, and compares it to the received response. This provides a service response 1407, whether accepted or refused, to the user and to the merchant. If accepted, the fulfilment of the transaction is performed as usual.

The above descriptions, although made with reference to a purchase transaction over the Internet, can also be used for, among other uses, replenishing prepaid cellular accounts, for voting, and for providing authenticated access to a network. Such a system could also be used at points of sale to digitally sign a transaction. For example, once identified by the cash register via a scanned bar code, RF chip, local RF signal from the mobile device, magnetic stripe, or any other unique identifier, and once a method of payment has been selected (pre-configured or selected on the spot), the present invention could be used by the user to sign the transaction. The invention also can be used to selectively and securely grant access to confidential or restricted information such as a medical file to insurance companies or other types of credentials such as age, nationality, etc. and where authorization with strong authentication is required.

One advantage of the present invention is that it removes the need for a user to provide confidential information, such as credit card numbers, over a public network, and the need for merchants to securely store that information. It is also a more robust system in that the merchant does not have access to the confidential information, only whether or not the transaction has been approved. This invention also allows for transactions that are not face-to-face (referred to by payment associations as mail order/telephone order—MOTO) to take place with high level of certitude about the legitimacy of the parties involved, their consent to transact, and a trace to prevent later repudiation of the transaction by any one party. Another advantage of the invention is that the digital signature of the owner of the method of payment can be obtained remotely and the good can be delivered to a third party located at the premises of the merchant. As an example, with this invention a parent can remotely authorize a transaction and initiate a payment for their child's purchases.

A mechanism is also provided within the system and method of the present invention to allow the end users to self manage their PINs using the same process as described above. By initiating a PIN change request, the user is first prompted to confirm and authorize a PIN change request by entering a current valid PIN. Following the validation of the response, a subsequent signing request is sent to the user requiring the entry of a new PIN. This is followed by a third signing request requiring the entry of the new PIN again for confirmation.

This process can be used to seal, at the moment of registration, the relationship between the end user and the system supporting the services made possible by the present invention. As an example, the user can register using his financial institution's automated teller machine (ATM). Having completed the registration process to the personal mobile device payment service by providing his bank PIN to the ATM, the service automatically requests an initial PIN change and the user uses this personal mobile device to select and confirm the new PIN. This has the potential to greatly simplify the registration process and is made possible because of the mobile nature of the service.

Although the present invention has been explained hereinabove by way of preferred embodiments thereof, it should be pointed out that any modifications to this preferred embodiment within the scope of the appended claims is not deemed to alter or change the nature and scope of the present invention.

1. A personal mobile device for effecting transactions with strong multi-factor end user authentication comprising:
means for receiving information related to a transaction and for sending a response;
a hardware secure module for processing said information related to a transaction and for calculating said response, said hardware secure module including encryption keys;
an interface for displaying said information, and for prompting said end user for an identification code; and
means for inputting said identification code and for approving said transaction.

2. A personal mobile device according to claim 1, wherein said information related to a transaction includes a challenge value, a label containing context information and a numerical value.

3. A personal mobile device according to claim 1, wherein said hardware secure module is a smart card.

4. A personal mobile device according to claim 1, wherein said response is calculated using the identification code, the transaction value, the challenge and encryption keys.

5. A personal mobile device according to claim 1, wherein said identification code is a PIN.

6. A system for effecting electronic transactions comprising:
a server and a personal mobile device,
said server being adapted to receive transaction information, to calculate a challenge and to transmit to said personal mobile device information relating to said transaction;
said personal mobile device including:
means for receiving information related to a transaction and for sending a response;
a hardware secure module for processing said information related to a transaction and for calculating said response, said hardware secure module including encryption keys;
an interface for displaying said information, and for prompting said end user for an identification code; and
means for inputting said identification code and for approving said transaction.

7. A system according to claim 6, wherein said server and said personal module device are in wireless communication.

8. A system according to claim 6, wherein said information related to a transaction includes a challenge value, a label containing context information and a numerical value.

9. A system according to claim 6, wherein said hardware secure module is a smart card.

10. A system according to claim 6, wherein said response is calculated using the identification code, the transaction value, the challenge and encryption keys.

11. A system according to claim 6, wherein said identification code is a PIN.

12. A device according to claim 1, wherein said device is a mobile telephone handset.

13. A system according to claim 6, wherein said device is a mobile telephone handset.

14. A system according to claim 6, wherein said server includes a hardware secure module for calculating a predicted response using the identification code, the transaction value, the challenge and encryption keys, and wherein said server compares said response and said predicted response in order to accept or refuse the transaction.

15. A method for effecting an electronic transaction with strong multi-factor end-user authentication, comprising the steps of:
(a) receiving a transaction request from a requesting entity at a server;
(b) calculating a challenge value;
(c) formatting a request including information related to said transaction;
(d) sending said request to a personal mobile device;
(e) receiving said request at said personal mobile device;
(f) processing said information related to said transaction with a hardware secure module located within said personal mobile device;
(g) displaying said information related to said transaction to said end user and prompting said user to approve said transaction;
(h) upon receipt of said approval of said transaction, prompting said user to enter an identification code;
(i) calculating a response to said request with said hardware secure module;
(j) sending said response to said server;
(k) at said server, receiving said response, verifying said response and either confirming or refusing said transaction based on said response.
